(19) United States
(12) Patent Application Publication
(10) Pub. No.: US 2026/0161753 A1
(43) Pub. Date: Jun. 11, 2026

(54) Dynamic Authentication Techniques

(71) Applicant: THROUGHPUTER, INC., Alexandria, VA (US)

(72) Inventor: Mark Henrik Sandstrom, Alexandria, VA (US)

(21) Appl. No.: 19/346,859

(22) Filed: Oct. 1, 2025

Related U.S. Application Data
(60) Provisional application No. 63/730,452, filed on Dec. 11, 2024.
(60) Provisional application No. 63/739,049, filed on Dec. 26, 2024.
(60) Provisional application No. 63/739,554, filed on Dec. 28, 2024.
(60) Provisional application No. 63/742,377, filed on Jan. 6, 2025.
(60) Provisional application No. 63/745,760, filed on Jan. 15, 2025.
(60) Provisional application No. 63/808,741, filed on May 20, 2025.

(51) Int. Cl. G06F 21/31

(52) U.S. Cl. CPC G06F 21/31; G06F 2221/2103

(57) ABSTRACT

This disclosure describes systems and methods for (i) processing an authentication quiz involving dynamic security questions based on time-varying state and usage history of an account being protected by such a quiz, (ii) preventing inauthentic attempts to recover access to a user account of a software application, as well as (iii) generating authentic and inauthentic class training samples for pattern matching or other machine learning based login attempt authenticity predictions, for usage in artificial intelligence assisted login systems.

### CROSS-REFERENCE TO RELATED APPLICATIONS

This application claims the benefit of the following applications:
[I] U.S. Provisional Patent Application Ser. No. 63/730,452, entitled “Generation of Training Samples for Pattern-matching based Authentication”, filed on Dec. 11, 2024;
[II] U.S. Provisional Patent Application Ser. No. 63/739,049, entitled “Suspect Login Attempt Handling”, filed on Dec. 26, 2024;
[III] U.S. Provisional Patent Application Ser. No. 63/739,554, entitled “Dynamic Authentication Quiz Processing”, filed on Dec. 28, 2024;
[IV] U.S. Provisional Patent Application Ser. No. 63/742,377, entitled “Adaptive Pattern Matching”, filed on Jan. 6, 2025;
[V] U.S. Provisional Patent Application Ser. No. 63/745,760, entitled “Multi-Dimensional Predictors”, filed on Jan. 15, 2025; and
[VI] U.S. Provisional Patent Application Ser. No. 63/808,741, entitled “Inauthentic Account Recovery Prevention”, filed on May 20, 2025.

This application further is related to the below US patent publications:
[VII] U.S. Utility patent Ser. No. 11/561,983, entitled “Online Trained Object Property Estimator”, filed on Mar. 6, 2020;
[VIII] U.S. Utility patent Ser. No. 11/599,624, entitled “Graphic Pattern-Based Passcode Generation and Authentication”, filed on Jun. 5, 2020;
[IX] U.S. Utility patent Ser. No. 11/604,867, entitled “Graphic Pattern-Based Authentication with Adjustable Challenge Level”, filed on Mar. 30, 2020;
[X] U.S. Utility patent Ser. No. 11/620,557, entitled “Online Trained Object Property Estimator”, filed on Feb. 22, 2020;
[XI] U.S. Utility patent Ser. No. 11/893,463, entitled “Online Trained Object Property Estimator”, filed on Jan. 10, 2023; and
[XII] U.S. Utility patent Ser. No. 12/306,929, entitled “Graphic Pattern-based Authentication with Adjustable Challenge Level”, filed on Feb. 2, 2023.

All preceding applications are incorporated by reference herein in their entireties.

### BACKGROUND

### Technical Field

This disclosure pertains to the field of digital authentication systems, more precisely, to such systems involving dynamic authentication questions and answers.

### Descriptions of the Related Art

Conventional login systems have mechanisms by which account holders (users) are, typically at account sign-up, asked to record answers to a set of authentication questions, which may then be queried from a login candidate such that precisely correct answers are required as a condition for sign-in. Drawbacks of such conventional authentication questions include that while the authentic login candidate will fail them if the answer typed at sign-in time does not match exactly the answers recorded at sign-up time, an inauthentic login candidate (incl. a computerized attacker) will be able to see the static authentication questions and may thus find information for and deduce their static answers. Such shortcomings can be addressed by techniques described in the following.

### SUMMARY

An aspect of the invention involves a dynamic quiz based authentication method for assessing authenticity of a login attempt to an account holder's account at a computer system, application or service. Embodiments of such method comprise: (1) keeping records concerning status of the account such as its usage history and account holder preferences; (2) at time of any login attempt to the account, computing from present state of the records M-times-N (with M and N being positive integers) instances of dynamic correct values, such as numbers of login events since the account creation or within a defined time frame, the time since the latest login event, information of user device or software used for previous login events, and the time since the account holder changed a given one of account settings such as the account recovery phone number or email address details, and/or account holder preferences concerning whether or how to receive alerts of login attempts or events to the account; (3) forming threshold values corresponding to such correct values, either above or below the respective correct values, for instance by dividing or multiplying the correct values by factors randomly ranging within defined limits and rounding the result thereof to a desired number of significant digits or closest integer; (4) producing true statements concerning the account status with respect to each of said threshold values; (5) dividing said statements to M subsets, and for each such subset of N statements, inverting each but a random one of the statements to make them false, such that in the resulting subsets, all but one of the statements are false; (6) prompting the login candidate to identify, from each of said subsets, the true statement concerning the present state of the account; and (7) determining whether the login candidate identified the correct statement from at least a minimum number of the subsets required for the login candidate to pass the dynamic quiz, and accordingly direct the login process to the respective next stage appropriate for a candidate passed or failed the authentication quiz. In alternative embodiments, the statements per above are first formed as false, and just one within each subset is inverted, so that, via either implementation alternative, within each of the M subsets of N statements presented to login candidate, there is one true statement to be identified as such by the login candidate. For an example statement such as “Within past 48 hours, there have been less than two login events to this account”, a possible inverted statement would be “Within past 48 hours, there have been two or more login events to this account”.

A further aspect of the invention involves a computer-based system performing the authentication method per above involving variants of the dynamic quiz per this description.

An aspect of the invention involves a method for preventing abuse of account access recovery mechanisms, with such a method requiring affirmation by the user of an application account that account recovery attempt is authentic before presenting the account recovery challenges to the login candidate, and, in case of absence of affirmation in a set time limit (e.g. up to 2 minutes), programmatically disabling account recovery attempts for a defined time period (e.g. 2 days) or until the authenticated user would login to one's account and re-enable the account recovery methods and reconfigures the account recovery challenges. A further aspect of the invention involves a computer equipment based system for implementing the method per above.

An aspect of the invention involves a method for generation of training samples for pattern-matching based authentication system including steps for: (a) recording a feature vector (FV) charactering aspects of a login attempt to an account of a given user; (b) prompting the given user to ascertain the login attempt as authentic or inauthentic; and (c) generating an authentic or inauthentic class training sample of the FV based on how the user ascertained the login attempt.

### BRIEF DESCRIPTION OF THE DRAWINGS

The drawings and tables (collectively, diagrams), which are incorporated in and constitute a part of the specification, illustrate one or more embodiments and, together with the description, explain these embodiments. Any values and dimensions illustrated in the diagrams are for illustration purposes only and may or may not represent actual or preferred values or dimensions. For clarity, some features of embodiments may be omitted from the drawings to assist in focusing the diagrams to the features being illustrated.

In the drawings, FIG. 1 illustrates an aspect of the invention involving a process for forming and processing dynamic authentication quizzes.

FIG. 2 illustrates a flow chart for preventing inauthentic online account recovery attempts, according to an aspect of the invention.

FIG. 3 illustrates an aspect of the present invention, where, for further machine learning enablement and unauthorized access or transaction prevention purposes, the login candidate is asked whether to send information of the login quiz correct answers to the recovery email address registered for the account, or at the candidate's choice, to an email address entered at a field provided.

General symbols and notations used in the drawings:
Boxes indicate a functional module comprising digital logic.
Arrows indicate a digital signal flow. A signal flow may include one or more parallel bit wires. The direction of an arrow indicates the direction of primary flow of information associated with it with regards to discussion of the system functionality herein, but does not preclude information flow also in the opposite direction. A gapped arrow indicates a control, rather than primary data, flow.
An arrow reaching to a border of a hierarchical module of a group of modules indicate connectivity of the associated information to/from all associated sub-modules.
Lines or arrows crossing in the drawings are decoupled unless otherwise marked.
For clarity of the drawings, generally present signals for typical digital logic operation, such as clock signals, or enable, address and data bit components of write or read access buses, are not shown in the drawings.
   The drawing element reference numerals are in the detail description that follows placed in parentheses to make it clear when a number refers to a drawing element, rather than to its numeric value.

### DETAILED DESCRIPTION

The description set forth below in connection with the diagrams is intended to be a description of various, illustrative embodiments of the disclosed subject matter. Specific features and functionalities are described in connection with each illustrative embodiment; however, it will be apparent to those skilled in the art that various embodiments may be practiced without each of those specific features and functionalities, as well as with modifications thereof.

Per illustration in FIG. 1, an embodiment of an aspect of the invention involves a login system where certain user-specific data records are held (110) for the user accounts, e.g., concerning settings such as the account recovery email address and/or phone number of the user, the opt-in/out selections of the user for receiving notifications of non-completed login attempts or successful login events to the account, etc.—which settings the user may change whenever signed-in to one's account. In addition, the system may keep records such as counts, timestamps and locations of login events to the user accounts, as well as device hardware and software specifics used for login events. Based on such time-variable state of such records, the login system will present the login candidates questions, e.g. “Was your latest sign-in to this account less than 48 hours ago” (where the latest sign-in was two weeks ago), such that the authentic user (account holder) would be able to readily answer correctly, but which others could not be able to consistently guess correctly.

According to some of such embodiments, the login candidates are presented (120), (130), (140) a set of statements concerning the account settings, login activity etc. against the present state of the records for the given account, and the login candidate is requested to identify the true one among such, e.g. four, statements of which the others are untrue (150); in such embodiments, the presented statements are phrased such as to not reveal the accurate present state of the matter. E.g., if the user had so far done 50 sign-ins to one's account, a corresponding untrue statement would be presented e.g. as the “There has been 20 or less sign-in events to the account (not counting the current one)” or “There has been at least 220 sign-in events to the account” such as to not suggest even the approximate amount of sign-ins to the account (even if the statement was correctly assumed to be untrue, noting that, among four statements, each statement would however have ¼th of likelihood of being true). In yet certain embodiments, the statements (most of which will be untrue) (150) will be presented to login candidate in the form per, corresponding to the above situation, that “There has been between 10 and 25 sign-in events to the account” or “There has been between 100 and 250 sign-in events to the account”. In such embodiments, in effect, two threshold values are produced, e.g. by dividing or multiplying the correct value by factors such as 2 and 5, and the statements will query whether the correct value is within the range between the two threshold values. In at least some embodiments, the factors used for multiplication (or division) will not be static, but will be randomly assigned for each login attempt within defined ranges, such that the verity of the presented statement should be readily knowable to each account holder, while not systematically guessable for others.

In at least some of such embodiments the login candidates are presented multiple sets (150) of such, e.g. four, statements from which they need to identify the true one, with the system requiring correct identification from at least some minimum number of such sets. For instance, if the login candidates are presented four such sets of statements, and the system requires the identification (160) of the (sole) correct statement from each of such four sets, the likelihood of passing (170, 180) the authentication quiz by random selections would be less than 0.4% (¼\hat{ }4=0.0039). As another example, requiring at least 4 correct identifications out of 6 sets of 5 statements could be passed by random choices per below:

$$( 6 choose 4 ) * {( 1 / 5 )}^{∧} 4 * {( 4 / 5 )}^{∧} 2 + ( 6 choose 5 ) * {( 1 / 5 )}^{∧} 5 * {( 4 / 5 )}^{∧} 1 + ( 6 choose 6 ) * {( 1 / 5 )}^{∧} 6 * {( 4 / 5 )}^{∧} 0 = 0. 1696 = 1.7 \% .$$

Yet as a further example, requiring at least 3 correct identifications out of 5 sets of 4 statements could be passed by random choices per below:

$$( 5 choose 3 ) * {( 1 / 4 )}^{∧} 3 * {( 3 / 4 )}^{∧} 2 + ( 5 choose 4 ) * {( 1 / 4 )}^{∧} 4 * {( 3 / 4 )}^{∧} 1 + ( 5 choose 5 ) * {( 1 / 4 )}^{∧} 5 * {( 3 / 4 )}^{∧} 0 = 0.1035 = 10.4 \% .$$

But the random-choice pass probability of quiz requiring at least 4 correct identifications out of 5 sets of 5 statements would be only:

$$( 5 choose 4 ) * {( 1 / 5 )}^{∧} 4 * {( 4 / 5 )}^{∧} 1 + ( 5 choose 5 ) * {( 1 / 5 )}^{∧} 5 * {( 4 / 5 )}^{∧} 0 = 0.00672 = 0.7 \% .$$

As such, even without requiring the login candidate to get every one of the multiple-choice questions correctly (160), the likelihood of passing (170, 180) the quiz with random choices can be brought to less than 1% while keeping the number of statements per set and the number of such sets (150) (from which to identify the true statement) reasonable so as to no inconvenience the account holders. Where login candidates can be required to make correct identification from each set (160), the random-choice pass probability can be brought to very low; e.g. by requiring correct identification from each of 5 sets of 4 questions, the likelihood of passing the quiz at random would ¼\hat{ }5=0.00098 i.e. less than 0.01%.

Per above examples, for given constant numbers of statements per a question and such questions per the quiz, a lower quiz pass probability with random choices is achievable by requiring each of the questions to be answered correctly. Note however that in embodiments where the authentication quiz is not the final step in the authentication process—e.g., where passing such a quiz is required for the login candidate to be able to complete the authentication based on menu choices, such as from menus of graphical patterns, selecting patterns sufficiently close to the pattern registered for the account by the authentic user, instead of having to reproduce the registered graphical pattern from blank slate—an advantage of allowing the quiz to be passed without requiring each of the questions (e.g. identification of the true one from a set of statements concerning the account status) to be answered correctly is that the event of passing the quiz will not give an attacker positive knowledge of which of the presented statements are true.

According embodiments of the invention, illustrated at FIG. 1, parameters of the quiz, e.g., numbers of statements per subsets and/or numbers of the subsets (from which the correct statement is to be identified by the login candidate) (150, 160) are adjusted according to a risk score assessed for the login attempt. Further, in some embodiments, the authentication quiz has to be completed within a time limit, the remainder of which may be displayed to the login candidate, at least at intervals such as 30 seconds (via alerts such as there is 1 minute, or 30 seconds, to complete quiz, etc.). Yet in some embodiments, the time limit to complete the quiz is adjusted according the login event risk score assessed, in some scenarios along with the quiz parameters per above. In at least some of such embodiments, the risk score is impacted by the number of login attempts to the account at issue, or the number of failed login attempts across all accounts of the login domain at issue, within defined time intervals e.g. the past four hours or two days.

The truth concerning the statements (140), e.g. the number of login attempts, should preferably be volatile and changing quickly. E.g., instead of presenting a statement concerning the total number of login attempts, the statements need to concern number of login attempts over a dynamic, randomly variable time frame, e.g. within last 12, 24, 48 hours, 3 to 7 days, or 1 or 2 weeks. For instance, a statement could read: “Over the past 48 hours, there has been less than 2 login events to this account.” or “Over the past 3 days, there has been more than 5 login events to this account.” Notably, per such embodiments, the time frame for such questions has to be dynamically computed.

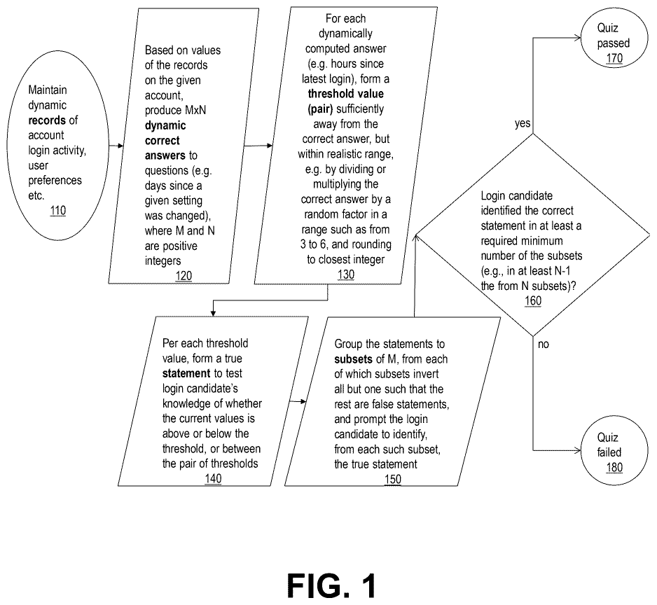

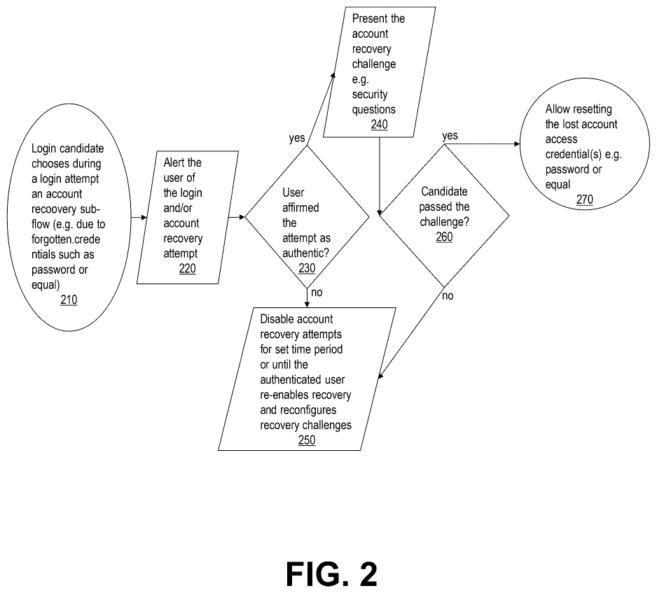

According to embodiments of the invention per FIG. 2, the application immediately alerts the user of any attempts to login, and/or recover access (210), to their account via messages (220) sent via their contact methods e.g. recovery email address and/or phone number on record for the account, which messages enable to user to immediately logout any existing sessions and disable (250), for a period definable by the use e.g. between 6 hours and 6 weeks, login or recovery attempts to their account. These alert messages further allow the user affirm (230), within a set time limit e.g. 2 minutes, that the login or account recovery attempt was authentic (240). For clarity and conciseness, the rest of this description regarding FIG. 2 focuses on the cases of account recovery, rather than regular login, attempts. An affirmation by a user (230, 240) for an account recovery attempt may further be accomplished via e.g. the login candidate being required (240) at the account recovery flow to enter, within a set time limit e.g. 15 seconds, the recovery phone and/or email contact details on record for the target user account, and in case the correct recovery contact details were entered, then return the verification code that was sent to recovery contact(s) on record for the account. In at least certain embodiments, account recovery attempt disabling (250) is done automatically by the system following the user's indication (230) of the given recovery attempt as inauthentic, while the challenge at step 240 may call for the account recovery candidate to answer correctly (260) security question set for the target account in order to proceed with recovering the account access (270).

Further, embodiments of the invention may require the login candidate to pass (240, 260) an authentication quiz, such as those per FIG. 1, in order for the account recovery attempt to be considered authentic (260), where such a quiz can involve the techniques per the references provisional application [III]. Moreover, according to certain embodiments, techniques per the references provisional application [II] may be used to prevent the account recovery attempts in cases where recovery contact details (e.g. email addresses or phone numbers) other than those registered for the target user account would be entered for the verification code to be sent.

If no completed affirmation of authenticity of the account recovery attempt is received within a time limit such as 1 to 5 minutes from the login candidate beginning the login attempt (entering the username of the target account), embodiments of the system will disable (250) account recovery attempts for a time period such as 1 to 5 days, or until the authenticated user logs in and reactivates the desired account recovery methods and reconfigures account recovery challenges (240), e.g., security question-answer pairs. In certain embodiments of the invention, once the authenticated user logs in to one's account for which recovery is disabled, the application user interface prompts and guides the user to reconfigure one's account recovery challenges (240), as well as the recovery contacts and access credentials (e.g. password or corresponding secret), and consequently, to re-enable the recovery mechanisms for one's account.

At least some embodiments will further automatically disable (250) account recovery attempts, until re-enabled by the authenticated user, in response to a failure of the account recovery candidate to pass the account recovery challenge (240, 260, 250).

As described herein, embodiments of the present invention enable a login system to learn, from user responses to account login or recovery attempt alert messages, what are the respective differentiating characteristics of authentic vs inauthentic login attempts. Per such embodiments of the present invention, the users' responses for login attempt alert messages are used to generate training samples based on the at-login-time recoded sets of features characterizing a given login attempt, with the training sample class (authentic or inauthentic) defined based on the user's response to the alert message prompting the user to ascertain the identified login attempt as authentic or inauthentic. According to various embodiments of the invention:
the login attempt alert messages are sent to appropriate the account holder (user) as soon as the features characterizing the given login attempt are recorded, and regardless of whether or how the login attempt is completed;
the user is allowed to correct one's login attempt ascertainment response once (which if done, will move the training sample to the class per the corrected ascertainment), after which at most one correction, and/or at specified time out such as 72 hours, the alert message will become passive (such that at most one training sample is generated per a login attempt);
after a set number of training samples are collected per a user account and per class in a shift-register, the incremental new training samples for the given class will shift-out the oldest training sample from the user and class specific shift-register;
moreover, besides the user specific shift-registers of inauthentic samples, the system maintains a cross-user shift-register of inauthentic samples, such that for pattern-matching an incoming login attempt (to predict its authenticity), the collection of inauthentic samples will be made of in part (e.g., up to one half to the degree that there are account-specific inauthentic samples collected for a given user) of inauthentic samples collected for the given user, with the rest being taken from the cross-user collection of inauthentic samples.
   Moreover, in at least some embodiments:
at account sign-up (registration), a certain number of known authentic login samples are collected for the authentic sample shift-register of the user;
all ascertained inauthentic samples, from login attempts to any user account of the given domain, are placed to the cross-user shift-register of inauthentic samples;
equal number of authentic and inauthentic training samples (e.g. ten and ten) are held for each user account, and when there would be some, but less than the defined quota of samples for the given class, duplicates of the existing samples are generated to fill up the quota;
initial samples for the inauthentic class are generated by taking scaled-down inverted-at-center mirror images of the FVs of collected for the user's login behavior at the account registration, and/or at initial ascertained authentic login events, where such inversion is done, for example when certain feature value range is 0 to 255 (such that the center point is 128), and a given known authentic sample value of that feature was 100, so that the scaled-down-by-half inverted value for the respective generated inauthentic sample will be 128+ (128−100)/2=142.
   For a practical reference, swarm plots of resulting training samples and a pattern-matching can be viewed in the specification of the reference provisional application [I].

Per above, embodiments of the invention achieves adaptive pattern-matching based machine-learning and streaming prediction technology, that is usable, besides the above considered example of predicting authenticity of a login event based on observation of the login candidate's interaction with the login system user interface (e.g. style of typing), for a large variety of applications where predicting a latent property of an observable event or process is valuable, including in changeable predicting environments where the characteristics and/or range of classes may evolve over time.

A further aspect of the invention involves a method for assessing authenticity of a login attempt where the login candidate is asked whether to send a verification passcode to the recovery phone number or email address registered for the account, or at the candidate's option, to a phone number or email address to be entered by the candidate at that time, and where, if the candidate enters a phone number or an email address other than any of those registered for the account holder for sending the passcode, the authentication system typically will prevent the candidate from logging in to the account (though it may send a random code to the entered phone number or email address), while it will also send an alert message to the recovery phone number and/or email addresses registered for the account, informing the account holder of the suspect login attempt, and asking the user to ascertain the authenticity of the identified suspect login attempt.

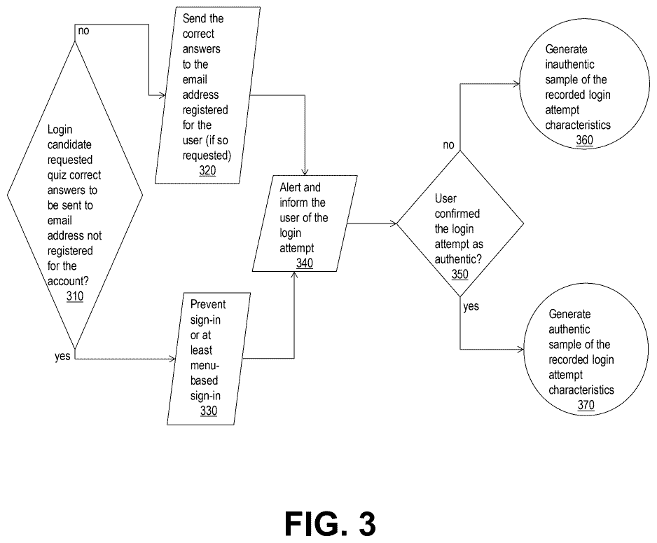

In certain embodiments of such aspect of the invention, the login candidates are asked whether to send a hint for the account password or other login credential (e.g. graphical pattern) to the recovery phone number or email registered for the account, or to a phone number or email address to be entered at that time, with the system treating the login attempt as likely inauthentic (per above, incl. preventing the sign-in to the account) if the candidate chooses to enter a phone number or an email address not registered for the account. Yet in certain embodiments, the login process involves a quiz, e.g. per FIG. 1, where the login candidate is asked about information derived programmatically from the account settings, status and usage history such that the authentic user should readily know at least approximately but which is not stored anywhere and which an inauthentic login candidate could not consistently guess correctly, to pass the quiz comprising a number of questions concerning such information. At the conclusion of the quiz, per FIG. 3, the login candidate is asked (310) whether to send the correct answers to the recovery email address (or phone number) registered for the account (320), or at the login candidate's choice, to an email address or phone number to be entered at a field provided (330). Similar to the above, cases where the login candidate chooses to enter a phone number or an email address not registered for the account will be treated as likely inauthentic login attempts, with an alert sent to the user (330, 340). Further, according to embodiments of the invention, recorded characteristics of such suspect login attempts (e.g. username typing pattern), when confirmed by the user as inauthentic (350), will produce training samples for inauthentic login attempts for a machine learning (ML) based login attempt authenticity prediction service accompanying the login system (360), while corresponding characteristics of login events verified (350) as done by the actual account holder are used as training samples for authentic login attempts (370), e.g., using techniques per the referenced provisional applications [I]. At a more general level, these aspects of the invention involve presenting during the login process for the login candidate alternatives, e.g. per the above example of the option to enter a phone number other than the one register for the account for the verification code, where the choices of the authentic and inauthentic candidates would tend to differ, in order to detect and prevent suspicious login attempts, and gather information about such suspicious login candidates and patterns characteristic of inauthentic login attempts. Operation of the herein discussed features of an exemplar embodiment of the present invention, where the login candidate is asked whether to send the login quiz correct answers to the recovery email address registered for the account, or at the candidate's choice, to an email address entered at a field provided, is illustrated at FIG. 3.

According to at least some embodiments, an alert (340) email and/or text message or equal is sent to the account holder of this login attempt in case any login attempt, for the user to ascertain the login attempt (350)—identified e.g. by its time, the login candidate's device, browser make and version, geographic location and the email address or phone number the candidate requested the quiz correct answers to be sent to—as either authentic or inauthentic, with the system generating a training sample for the respective class (360, 370) of the recorded login attempt characteristics (e.g. the login attempt identification data per above, the account username typing pattern etc.) for training a ML service used to predict authenticity of future login attempts, with such predictions used to adjust the authentication challenge level accordingly—increasing the difficulty of authentication challenges for candidates whose login behavior patterns do not match the respective models for authentic account holders.

The operation of this aspect of the invention will follow similar principles for embodiments where the login candidate is asked, instead of or in addition to the correct answers to the quiz, e.g. whether to send a verification passcode or password/credential hint to the registered recovery email or phone number, or at the candidate's choice, to an email or phone number provided at that time.

According certain embodiments of the invention, while no information useful for an inauthentic login candidate (or computerized attacker) will be sent to the email addresses or phone numbers provided at the login time, such email addresses and phone numbers will be used by the authentication system to learn of characteristics of inauthentic login attempts. In embodiments where email addresses or phone numbers entered during such suspect login attempts are displayed to the account holders, e.g. for identification of the login attempt the user is requested to confirm as authentic or inauthentic, some characters of the email or phone contacts of the suspected attackers are masked, to prevent users from contacting such parties.

One or more of the above described techniques can be used in digital and online authentication applications, e.g., per the referenced provisional applications [I], [II], [III] and [VI].

Besides the users' login attempt authenticity affirmation feedback techniques per these mentioned references [I] etc., applications of the techniques per this disclosure for login attempt (or generally online visitor or transaction) authenticity prediction may use login (etc. online transaction) candidate voice recording based FVs (along with the username typing pattern based FVs), and in some applications, the labeling of the FVs for authentic or inauthentic classes and any respective sub-types may involve providing, e.g. via an audio file attached to or linked from an email asking the authentic user to affirm the authenticity of a given login attempt, the user with an opportunity to play back the voice recording captured at the given login (or other transaction) attempt for the user to accordingly provide feedback to the system by affirming the case regarding authenticity of the respective attempt, along with identification of any applicable sub-class, e.g., inauthentic female voice, inauthentic male voice, inauthentic non-human-voice, or inauthentic inaudible (silence), as such subclasses may have their distinct clusters in the applicable feature spaces of the voice recognition FVs. Furthermore, as an alternative or in addition to such voice recording, authentication or authorization applications of techniques per the present disclosure and the referenced applications [I]-[VI] may use transaction (e.g. funds transfer) submitter candidate photo or video recordings, for pattern matching based authenticity prediction, as well as for the user to ascertain the truth concerning authenticity thereof, and applicable subclasses in case of inauthentic transaction attempts, based on a display or replay of photo or video captured of the submitter candidate at any given attempt of a sensitive transaction. Moreover, embodiments for these features may involve techniques per FIG. 3 and related descriptions above, by allowing the login candidate to enter alternative contact details for sending an authentication verification code, with the messages requesting the authentic user to ascertain and sub-type the (in) authenticity of the given login attempt displaying to the user the contact details (e.g. email address or phone number) entered by the login candidate for the sending of the verification code. These augmented authentication and authenticity ascertainment methods will improve the accuracy of the users' affirmations of the transaction attempt authenticity or inauthenticity classes and subclasses, as well serve as a deterrent against inauthentic login etc. transaction attempts, by exposing the party attempting an unauthorized transaction and capturing suspect-identifying evidence of such attempts.

Hierarchical and online trained pattern matching based ML and streaming prediction techniques per the referenced patents [VII], [X] and [XI] may be used in various embodiments of systems and methods per the present disclosure. Implementations of authentication applications of embodiments of techniques per this disclosure can apply teachings in the referenced patents [VIII], [IX] and [XII].

The streaming data path functionality described herein, at least where not otherwise mentioned, can be implemented by hardware logic for minimized latency and maximized throughput (where hardware logic naturally also includes any necessary signal wiring, memory elements and such) with such hardware logic being able to operate without active software involvement beyond initial system configuration and any subsequent system reconfigurations. The hardware logic may be synthesized on a reprogrammable computing chip such as a field programmable gate array (FPGA) or other reconfigurable logic device. In addition, such hardware logic may be hardcoded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality. Aspects of the streaming data path functionality may be delivered via a network computing environment, such as a cloud computing environment.

Generally, this description and drawings are included to illustrate architecture and operation of practical embodiments of the disclosure, but are not meant to limit its scope. For instance, even though the description does specify certain system elements to certain practical types or values, those of skill in the art will realize, in view of this description, that any design utilizing the architectural or operational principles of the disclosed systems and methods, with any set of feasible types and values for the system parameters, is within the scope of the teachings. Moreover, the system elements and process steps, though shown as distinct to clarify the illustration and the description, can in various embodiments be merged or combined with other elements, or further subdivided and rearranged, etc., without departing from the scope of the teachings. Finally, those of skill in the art will realize that various embodiments of the present disclosure can use different nomenclature and terminology to describe the system elements, process phases etc. technical concepts in their respective implementations. Generally, from this description many variants will be understood by those skilled in the art that are yet encompassed by the scope of the teachings as set forth herein.

What is claimed is:

1. A dynamic quiz based authentication method, implemented using computer hardware and software, for assessing authenticity of a login attempt to an account holder's account, the method involving:
maintaining records concerning status of the account;
at time of the login attempt by a login candidate to the account, assessing dynamic correct values, referred to as dynamically assessed correct values (DACVs), characterizing the account status from a present state of the records;
producing a set of true and false statements concerning the account status with respect to at least some of the DACVs;
prompting the login candidate to give answers for questions regarding whether individual statements of the set are true or false; and
determining whether the login candidate passed the dynamic quiz based on a degree of correctness of the answers given by the candidate.

2. The method of claim 1, further involving a step of forming threshold values corresponding to at least some of the DACVs, above and/or below the respective DACVs, wherein at least some of the set of true and false statements concerning the account status are made in relation to said threshold values.

3. The method of claim 1, wherein
the assessing involves computing M-times-N instances of the DACVs from a present state of the records, where M and N are positive integers,
the producing involves dividing said statements to M subsets, and, for each such subset of N statements, inverting each but a random one of the statements to make them false, such that in resulting subsets, all but one of the statements are false, and
the prompting involves requesting the login candidate to identify, from each of said subsets, the true statement concerning the account.

4. The method of claim 3, wherein the determining involves resolving whether the login candidate identified the true statement from at least a required minimum number of the subsets.

5. The method of claim 1, where the DACVs relate to a number of login events to the account,
a number of login events to the account within a given time frame,
time since the latest login event to the account,
information of user device or software used for latest login event or previous login events and/or
time since the account holder reconfigured a certain configurable parameter for the account.

6. The method of claim 1, where the DACVs include present values of account-holder configurable account settings.

7. The method of claim 7, where the account-holder configurable account settings include
an account recovery phone number,
an account recovery email address, and/or
account holder preferences concerning whether and/or how to receive alerts of login attempts or login events to the account.

8. A system for performing the method of claim 1, involving digital hardware and/or software logic for carrying out its steps.

9. A method, implemented using computer hardware and software, for preventing inauthentic user account recovery attempts involving:
requesting an affirmation that an account recovery attempt is authentic; and
in case said affirmation is received within a defined time window, presenting the login candidate a set of challenges for recovering access to account, while otherwise, programmatically disabling account recovery attempts for a defined time period, or until the authenticated user logs in to one's account and re-enables the account recovery methods and/or reconfigures the account recovery challenges.

10. The method of claim 9, wherein the affirmation by the user involves at least one of:
the login candidate typing correctly within a set time limit the recovery contact details for the account;
the login candidate correctly returning a verification code sent to recovery phone and/or email contacts on record for the account within a set timeout period;
the login candidate passing a quiz testing the candidate's knowledge of usage and configuration parameters of the account.

11. A system for performing the method of claim 9, involving digital hardware and/or software logic for carrying out its steps.

12. A method, implemented using computer hardware and software, for generation of training samples for pattern-matching based authentication, the method involving:
recording a feature vector (FV) charactering aspects of a login attempt to an account of a given user;
prompting the given user to ascertain the login attempt as authentic or inauthentic;
generating an authentic or inauthentic class training sample of the FV based on how the user ascertained the login attempt.

13. The method of claim 12, wherein the prompting involves sending a message to the given user via phone and/or email contacts on record for the account of the given user.

14. The method of claim 13, wherein the message describes the login attempt by its time, geographic location, Internet access provider, device and/or browser type.

15. The method of claim 13, wherein the message describes the login attempt by a message delivery contact information given by the login candidate for sending an authentication verification code.

16. The method of claim 13, wherein the message characterizes the login attempt by a re-playable recording captured of said attempt.

17. The method of claim 13, wherein the re-playable recording of the login attempt includes a photo of the login candidate.

18. The method of claim 13, wherein the re-playable recording of the login attempt includes a video of the login attempt.

19. The method of claim 13, wherein the re-playable recording of the login attempt includes a voice recording of the login attempt.

20. A system for performing the method of claim 12, involving digital hardware and/or software logic for carrying out its steps.
